(19) United States
(12) Patent Application Publication
(10) Pub. No.: US 2007/0206578 A1
(43) Pub. Date: Sep. 6, 2007

(54) Portable network communication device for transmitting and receiving voice over network

(75) Inventors: Chien Chung Cheng, Hsinchu City (TW); Yi Yuan Yang, Hsinchu City (TW); Kuen Ruey Lu, Hsinchu City (TW)

Correspondence Address: BIRCH STEWART KOLASCH & BIRCH, PO BOX 747, FALLS CHURCH, VA, 22040-0747, US

(73) Assignee: Accton Technology Corporation, Hsinchu (TW)

(21) Appl. No.: 11/365,937

(22) Filed: Mar. 2, 2006

(51) Int. Cl. H04L 12/66

(52) U.S. Cl. 370/356

(57) ABSTRACT

A personal gateway comprises a controller for processing data, a phone driver coupled to the controller for driving internet phone application. An internet middleware is coupled to the controller to process voice over internet protocol (VoIP) communication. A voice and data port is coupled to the controller for coupling an external VoIP phone and at least one network connector coupled to the controller for network connection. A power is coupled to the controller and a bus port coupled to the controller for downloading or power charging.

### FIELD OF THE INVENTION

The present invention relates generally to a network communication device, and more particularly to a wired network communication device for transmitting and receiving Voice over Network for operating VoIP phone.

### BACKGROUND OF THE INVENTION

The conventional Interactive Voice Response (IVR) employed the long-established Public Switched Telephone Network (PSTN) for information transmission. Under the PSTN circuit-switched calls, a communication channel was exclusively dedicated to a conversation for its duration. As a result, the telephone service provider had to bill the calling party for the use of the line for the entire duration of the call. Hence, the conventional systems were too costly for domestic users or small business.

In recent years, with the progress of the network technology observed mainly as the wide-band of the LAN and the progress of the PC technology by the increasing versatility of computers and the speed of CPUs, it has become possible to transmit the audio and video data between PCs of a plurality of LANs at a high speed to practical use. As requirements for the ability to transfer large amounts of data between computing entities has grown, demand for efficient transfer of the data within and between computing networks has also increased.

The Internet development and growth seem to be the remarkable matter during the last ten-years. The influence of the Internet on people's daily life is self-evident. Nowadays, the user does not need to go to the real world to fetch information and exchange information. Exchanging information is the primitive purpose of the Internet development. Originally, people on Internet interchange messages by means of a mail, a BBS (Bulletin Board System) or a website board. The demand of users accompanying with the Internet growth is a more instant and convenient method or device for communicating.

In recent years, the IP telephony has been making inroads into the realm of telephone communications. Internet Protocol (“IP”), or Voice over IP (“VoIP”) enables the transmission of voice calls and other multimedia over data networks such as the Internet or corporate enterprise networks. Local IP Telephony gateways act as interfaces between local telephone and data networks to pick-up and hand-off calls. At the gateways, signals are compressed and decompressed, packetized and reassembled. Dedicated communications lines and networks (such as a fiber optic cable), with controlled and select data transmission, can obviate latency delays. Soon after that, VoIP (voice over IP) technology, like peer to peer IP phone, comes up. VoIP sends and receives calls in an instant way by the usage of an adapter to convert voice signals into data packets for Internet transmission. Since this technology has the potential to provide increased communication flexibility and much cheaper phone service, particularly internationally, more and more enterprises adopt VoIP technology. The present invention addresses such problems to provide a novel method and system for operating VoIP via a peer to peer IP communication device.

### SUMMARY OF THE INVENTION

According to solve the aforementioned weakness, the present invention offers a more convenient way for a VoIP user. With the more convenient way, any caller could simply make a call through VoIP phone by means of internet anywhere in which has an internet port.

For the purpose of the present invention, a portable network VoIP communication device for operating VoIP phone is disclosed. A portable network communication device comprises a controller for processing data and a voice over internet protocol module coupled to the controller to process voice over internet protocol (VoIP) communication. A voice and data port is coupled to the controller for coupling an audio device, a network module is coupled to the controller for network connection. A battery power source is coupled to the controller and a downloading and/or power charging bus port coupled to the controller for downloading and/or power charging. The downloading and/or power charging bus port includes a universal serial bus port. The downloading and/or power charging bus port is USB port or IEEE 1394 bus port. The voice over internet protocol module includes a peer to peer IP phone module and the network module could be a LAN connector and/or WAN connector. The device further includes memory and OS coupled to the controller.

In preferred embodiment, the audio device maybe a speaker coupled to an audio out port of the voice and data port and a microphone coupled to an audio in port of the voice and data port. Alternatively, the voice and data port has a port for coupling a VoIP phone. In the situation, the audio device could be a VoIP phone.

### BRIEF DESCRIPTION OF THE DRAWINGS

FIG. 1 is the block diagram of one embodiment according to the present invention.

### DETAILED DESCRIPTION OF THE PREFERRED EMBODIMENT

In the following description, numerous specific details are provided in order to give a thorough understanding of embodiments of the invention. One skilled in the relevant art will recognize, however, that the invention may be practiced without one or more of the specific details. In other instances, well known structures, materials, or operations are not shown or described in order to avoid obscuring aspects of the invention.

Referenced throughout the specification to “one embodiment” or “an embodiment” means that a particular feature, structure, or characteristic described in connection with the embodiment and included in at least one embodiment of the present invention. Thus, the appearances of the phrase “in one embodiment” or “in an embodiment” in various places throughout the specification are not necessarily all referring to the same embodiment. Furthermore, the particular features, structures, or characteristics may be combined in any suitable manner in one or more embodiments.

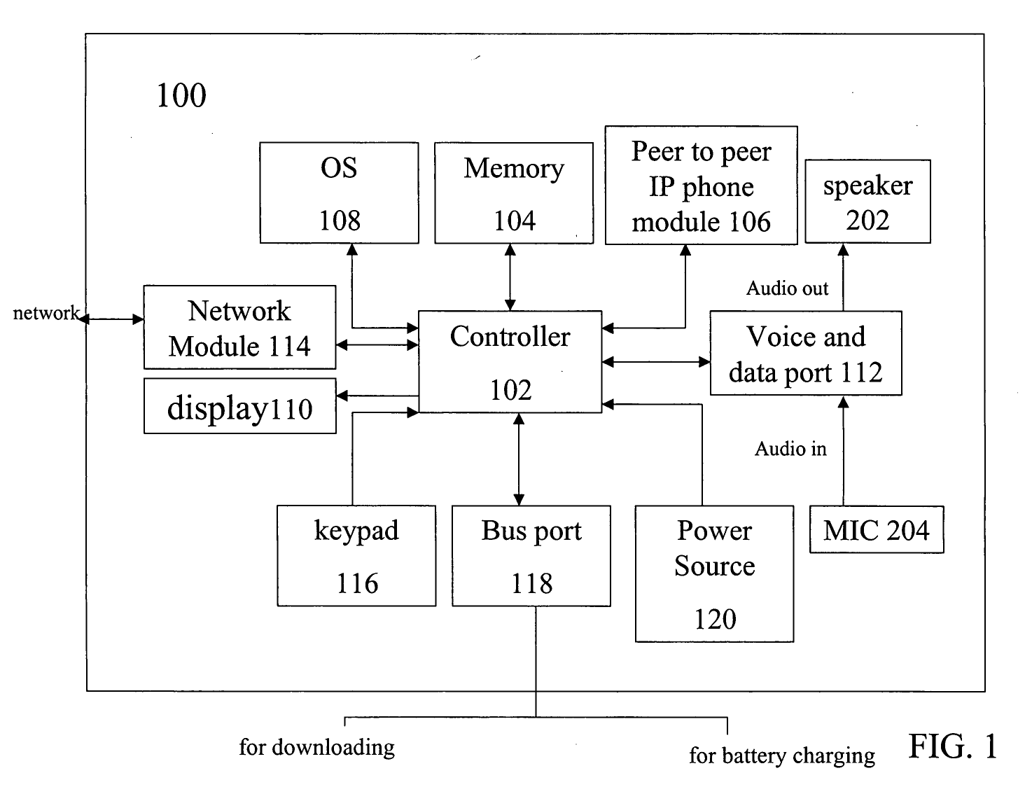

The present invention provides a compact networking device for business travelers and home user. The user may portably carry the personal and portable device for travel. The user may enable the internet phone communication via the portable network communication device while the device couples to an internet. An external VoIP phone may easily connect to the personal network communication device. Furthermore, the portable network communication device has a battery power, an external power is not necessary after the device is charged. FIG. 1 shows a block diagram according to one embodiment of the present invention. The portable network communication device 100 that includes a controller 102 equipped in a housing to process the signal or instruction. A voice and data port 112 is coupled to the controller 102. In one embodiment, the voice and data port 112 could be used to couple to an audio device, for instance a VoIP phone with built-in USB connector. Alternatively, a speaker 202 is coupled to the audio out port of the voice and data port 112 and a microphone (MIC.) 204 is coupled to an audio in port of the voice and data port 112. A peer to peer VoIP module or firmware 106 is provided and coupled to the controller 102 to drive the internet phone application. In one case, voice over internet protocol firmware 106, such as peer to peer IP phone module, is coupled to the controller 102 to enable the voice over internet protocol communication.

The portable network communication device 100 also includes plurality of auto-sensing Fast Ethernet connecters for Ethernet connection. For example, network module 114 is coupled to the controller 102 for wide and/or local area network connecting (WAN and/or LAN). Preferably, the present invention may provide two Ethernet ports, for instance, it provided with IEEE 802.3 Fast Ethernet MAC and PHY, and/or with IEEE 802.3 Fast Ethernet MAC and reversed MII interface. The WAN allows the user to communicate across a greater distance. The LAN is typically for local communication such as within a small location, building. Each ISP transfers data between the users and is able to communicate with other entities within the network.

An OS (operation system) 108 is employed into the portable network communication device 100 and is coupled to the controller for system operation as known in the art. Memory 104 is provided and coupled to the controller 102 to store software, instruction, data and information. The controller 102 is coupled to the memory to fetch or store information from or into the memory. Typically, the memory includes SDRAM and FLASH. Power source 120 is provided, in one preferred embodiment, the power source 120 could be, for example, a battery which is convenience and ease for portable application. A bus port 118 is coupled to the controller 102. The bus port 118 has two major functions. One is employed for download information through the network module 114 that is coupled to the Ethernet. Another function is to charging the battery when an external power adapter (not shown) is coupled to the bus port 118 for charging the battery. Preferably, the bus port 118 is a universal serial bus (USB) port or IEEE 1394 port. A key pad 116 and a display 110 are respectively provided and coupled to the controller 102 to input instruction and display as well know in the art.

From the foregoing, it will be appreciated that specific embodiments of the invention have been described herein for purposes of illustration, but that various modifications may be made without deviating from the spirit and scope of the invention. Accordingly, the invention is not limited except as by the appended claims.

We Claim:

1. A portable network communication device for transmitting and receiving voice over a network, which comprises:
a controller for processing data;
a peer to peer IP phone module coupled to said controller to process voice over internet protocol (VoIP) communication;
a voice and data port coupled to said controller for coupling an audio device;
a network module coupled to said controller for network connection; and
a downloading and/or power charging bus port coupled to said controller for downloading and/or power charging.

2. The portable network communication device as set forth in claim 1, wherein said peer to peer IP phone module includes a voice over internet protocol module.

3. The portable network communication device as set forth in claim 1, wherein said network module includes a LAN connector.

4. The portable network communication device as set forth in claim 1, wherein said network module includes a WAN connector.

5. The portable network communication device as set forth in claim 1, wherein said downloading and/or power charging bus port includes a universal serial bus port.

6. The portable network communication as set forth in claim 1, wherein said downloading and/or power charging bus port includes an IEEE 1394 bus port.

7. The portable network communication as set forth in claim 1, further comprising a keypad.

8. The portable network communication as set forth in claim 1, further comprising a battery power source.

9. The portable network communication as set forth in claim 1, further comprising an OS coupled to said controller.

10. The portable network communication as set forth in claim 1, further comprising a memory coupled to said controller.

11. The portable network communication as set forth in claim 1, wherein said audio device includes a speaker coupled to an audio out port of said voice and data port.

12. The portable network communication as set forth in claim 1, wherein said audio device includes a microphone coupled to an audio in port of said voice and data port.

13. The portable network communication as set forth in claim 1, wherein said voice and data port has a port for coupling a VoIP phone.
